(19) United States
(12) Patent Application Publication
(10) Pub. No.: US 2024/0116277 A1
(43) Pub. Date: Apr. 11, 2024

(54) METHOD OF PRODUCING COMPONENT-ATTACHED VEHICLE WINDOW

(71) Applicant: AGC Inc., Tokyo (JP)

(72) Inventors: Shunji UEDA, Tokyo (JP); Kenichi EBATA, Tokyo (JP)

(73) Assignee: AGC Inc., Tokyo (JP)

(21) Appl. No.: 18/528,253

(22) Filed: Dec. 4, 2023

Related U.S. Application Data
(63) Continuation of application No. PCT/JP2022/022975, filed on Jun. 7, 2022.

(30) Foreign Application Priority Data
Jun. 10, 2021 (JP) 2021-097652

(51) Int. Cl. B32B 17/10

(52) U.S. Cl. CPC B32B 17/10981; B32B 17/10036; B32B 17/10302; B32B 17/10761; B32B 2605/00

(57) ABSTRACT

A method of producing component-attached vehicle window glass includes disposing a component on a main surface of a glass plate having a heat absorbing layer via an adhesive, locally heating the heat absorbing layer, and transferring heat from the heat absorbing layer to the adhesive to heat and cure the adhesive.

### CROSS-REFERENCE TO RELATED APPLICATIONS

This application is a continuation of International Application PCT/JP2022/022975, filed on Jun. 7, 2022 and designated the U.S., which is based on and claims priority to Japanese patent application No. 2021-097652 filed on Jun. 10, 2021, with the Japanese Patent Office. The entire contents of these applications are incorporated herein by reference.

### BACKGROUND OF THE INVENTION

### 1. Field of the Invention

The present disclosure relates to a method of producing component-attached vehicle window glass.

### 2. Description of the Related Art

A configuration in which a component such as a mirror base or a bracket is bonded to the main surface of vehicle window glass with an adhesive is known. Production of such component-attached vehicle window glass generally includes a curing process for sufficiently curing the adhesive after the component is attached to the vehicle window glass via the adhesive.

Various methods have been studied to shorten the time of the curing process. For example, Patent Document 1 (Japanese Patent Application Laid-Open No. 2016-55741) describes a method in which an adherend and an adhesive surface of automobile glass are bonded to each other using an adhesive, and the adhesive is then cured using a superheated steam generator.

Patent Document 1 describes that as an effect of the disclosure, an adhesive can be cured in a short time without requiring a large-scale apparatus. However, the superheated steam furnace described in Patent Document 1 needs to have a size sufficient to cover the entire adherend, and requires devices such as a boiler and a heater in addition to the furnace. Therefore, unfortunately, the equipment in the related art is still large and complex. Furthermore, since it is necessary to blow high-temperature steam to cure the adhesive, there are concerns about positional deviation, deformation of the adhesive, and the like, when a small component is bonded.

### SUMMARY

According to an aspect of the present disclosure, a method of producing component-attached vehicle window glass includes disposing a component on a main surface of a glass plate having a heat absorbing layer via an adhesive, locally heating the heat absorbing layer, and transferring heat from heat absorbing layer to the adhesive to heat and cure the adhesive.

### BRIEF DESCRIPTION OF DRAWINGS

FIG. 1 illustrates an example of component-attached vehicle window glass according to an embodiment of the present disclosure;

FIG. 2 is a partially enlarged cross-sectional view taken along line I-I in FIG. 1;

FIG. 3 is a diagram illustrating an example of a heating process in the production of the component-attached vehicle window glass according to the embodiment of the present disclosure; and

FIG. 4 is an enlarged cross-sectional view taken along line II-II in FIG. 3.

### DESCRIPTION OF THE PREFERRED EMBODIMENT

In view of the above-mentioned problem, an object of the present disclosure is to provide a method capable of producing component-attached vehicle window glass in a short time and in a space-saving manner.

Hereinafter, an embodiment of the present disclosure will be described with reference to the drawings. In the drawings, the same or corresponding components are denoted by the same reference numerals, and description thereof may be omitted.

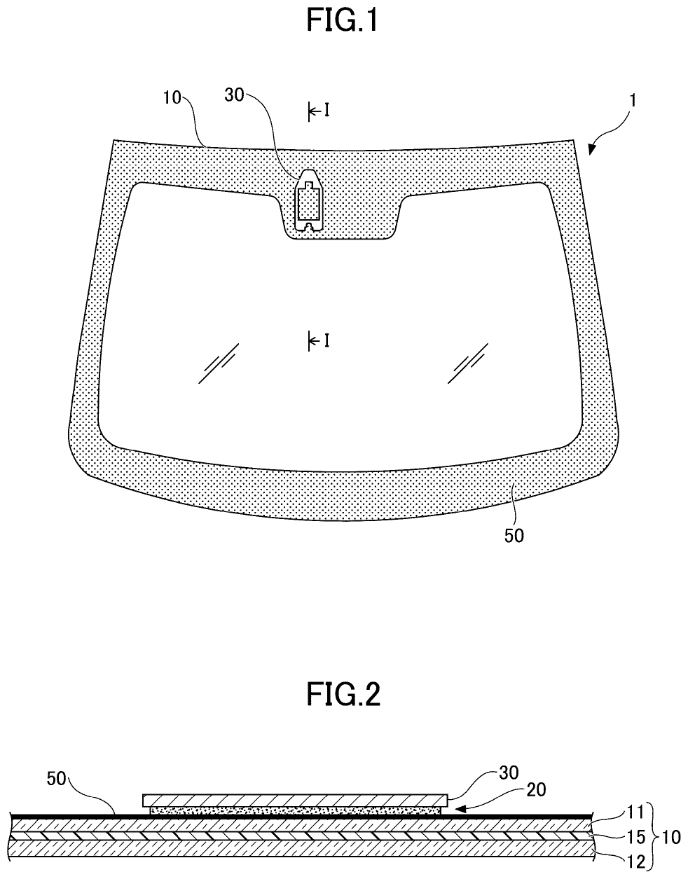

FIG. 1 is a diagram of an example of a component-attached vehicle window glass 1 produced according to the present embodiment as viewed from a vehicle-interior surface side. FIG. 2 is a partially enlarged cross-sectional view taken along line I-I in FIG. 1. As illustrated in FIG. 1 and FIG. 2, a component 30 is bonded to the main surface of a vehicle window glass 10, and an adhesive 20 is used for the bonding. In the illustrated example, the component 30 is a resin bracket, and the resin bracket is bonded to an upper portion and in the vicinity of the center in the left-right direction on the vehicle-interior surface of the vehicle window glass 10 (FIG. 1). Although the vehicle window glass 10 in FIG. 1 is a windshield, the vehicle window glass in the present embodiment may be a rear glass, a side glass, a roof glass, or the like.

As illustrated in FIG. 1 and FIG. 2, a heat absorbing layer 50 is formed on a peripheral edge portion of the vehicle window glass 10. As will be described later, the configuration of the heat absorbing layer 50 is not particularly limited as long as it is a layer having high heat absorbability.

However, the heat absorbing layer 50 is preferably a shielding layer (black ceramic layer) formed by applying a ceramic paste (glass paste) colored in black, gray, or dark brown, and firing the paste. The shielding layer has a function of protecting a sealant or the like that bonds the vehicle window glass to a vehicle body and holds the glass from ultraviolet rays or the like. In the example of FIG. 1 and FIG. 2, the adhesive 20 is in contact with the heat absorbing layer 50.

As the vehicle window glass 10 used in the present embodiment, a glass plate made of soda lime silicate glass, aluminosilicate glass, borate glass, lithium aluminosilicate glass, borosilicate glass, or the like may be used. The process of forming the glass plate is not particularly limited, however, the glass plate is preferably a glass plate formed by a float process, for example. The glass plate may be non-tempered glass, or may be tempered glass which is being subjected to a tempering treatment such as an air-cooled tempering treatment or a chemically tempering treatment. The non-tempered glass is obtained by forming molten glass into a plate shape and annealing. The tempered glass is obtained by forming a compressive stress layer on the surface of non-tempered glass. In a case where the tempered glass is air-cooled tempered glass, the glass surface may be tempered by rapidly cooling the heated glass plate from the temperature near the softening point to generate compressive stress on the glass surface due to a temperature difference between the glass surface and the inside of the glass. In a case where the tempered glass is chemically tempered glass, the glass surface may be tempered by generating the compressive stress on the glass surface by an ion exchange method or the like. Furthermore, the vehicle window glass is preferably transparent, however, the glass may be colored to such an extent that the transparency is not impaired. The shape of the glass is not particularly limited to a rectangular shape, and may be processed into various shapes. The glass plate used for the vehicle window glass may be bent and curved. Gravity bending, press bending, or the like is used as the bending.

The vehicle window glass 10 may be a single plate glass or laminated glass (FIG. 2). The laminated glass is glass obtained by bonding glass plates 11 and 12 via an intermediate film 15. The glass plates used for the laminated glass uses the above-described glass.

In the laminated glass, the material of the intermediate film 15 (FIG. 2) disposed between the glass plates 11 and 12 is not particularly limited, however, it is preferably a thermoplastic resin. Specific examples of the material of the intermediate film include a conventionally used thermoplastic resin such as a plasticized polyvinyl acetal-based resin, a plasticized polyvinyl chloride-based resin, a saturated polyester-based resin, a plasticized saturated polyester-based resin, a polyurethane-based resin, a plasticized polyurethane-based resin, an ethylene-vinyl acetate copolymer-based resin, an ethylene-ethyl acrylate copolymer-based resin, a cycloolefin polymer resin, an ionomer resin, and the like. A resin composition containing a modified block copolymer hydride described in Japanese Patent No. 6065221 can also be suitably employed. Among the above-described resins, the plasticized polyvinyl acetal-based resin is preferably used because of its excellence in terms of balance of performances, such as transparency, weather resistance, strength, bond strength, resistance to penetration, absorbability for impact energy, humidity resistance, thermal insulating property, and sound insulating property. The above-described thermoplastic resin may be used singly, or two or more types of thermoplastic resins may be used in combination. The term “plasticized” in the above-described plasticized polyvinyl acetal-based resin means that the resin is plasticized by adding a plasticizing agent. The same applies to the other plasticized resins.

The intermediate film may be a resin not containing a plasticizer, for example, an ethylene-vinyl acetate copolymer resin. The above-described polyvinyl acetal-based resin may include, for example, polyvinyl formal resin that is obtained by reacting polyvinyl alcohol (PVA) and formaldehyde, narrowly defined polyvinyl acetal-based resin that is obtained by reacting PVA and an acetaldehyde, polyvinyl butyral resin (PVB) that is obtained by reacting PVA and n-butyl aldehyde, and the like. Especially, PVB is preferable, because of its excellence in terms of balance of performances, such as transparency, weather resistance, strength, bond strength, resistance to penetration, absorbability for impact energy, humidity resistance, thermal insulating property, and sound insulating property. The above-mentioned resins may be used singly, or two or more types of polyvinyl acetal-based resins may be used in combination.

In the case of laminated glass, the entire vehicle window glass (including the intermediate film) may be between 2.3 mm and 8.0 mm, inclusive. The thicknesses of the glass plates constituting the laminated glass may be between 0.5 mm and 3.5 mm, inclusive. The thicknesses of the glass plates may be the same as or different from each other. The thickness of the vehicle-interior side glass plate may be between 0.5 mm and 2.3 mm, inclusive.

On the other hand, the component 30 is not particularly limited as long as it is a component that is attached to any location on the main surface of the vehicle window glass 10. The component 30 may be a mirror base (the example in FIG. 1) for mounting an inner mirror, a bracket for mounting a sensor, a camera, or the like, a molding, a protector, a pin, a holder, a hinge, or the like.

The material of the component 30 is also not particularly limited, and may be made of metal, resin, a combination of metal and resin, or other materials. The metal constituting the component 30 may be a single metal composed of one kind of metal element or may be an alloy. The metal may be, for example, aluminum, zinc, iron, stainless steel, or the like. The resin used for the component 30 may be a thermosetting resin or a thermoplastic resin. Examples of such resins include polyesters such as polyethyleneterephthalate (PET) and polybutyleneterephthalate (PBT), polyolefins such as polyethylene (PE) and polypropylene (PP), polycarbonate (PC), polyamides (PA) such as nylon 6 and nylon 6,6, high heat-resistant polyamides based on terephthalic or isophthalic acids (PA6T, PA6I, PA6T/6I, or the like), polyimide (PI), polyetherimide (PEI), acrylonitrile-butadiene-styrene (ABS), polyacetal (POM), polyvinylchloride (PVC), epoxies (EP), and the like.

As described above, the heat absorbing layer 50 provided on the glass plate of the vehicle window glass is a layer made of a material capable of absorbing heat and conducting the absorbed heat, or absorbing energy (for example, light energy such as heat rays) supplied from the outside and converting the absorbed energy into heat to obtain heat. The heat obtained by the heat absorbing layer 50 can be conducted to the adhesive 20. In the example illustrated in FIG. 1 and FIG. 2, the heat absorbing layer 50 is a shielding layer (black ceramic layer), but the heat absorbing layer 50 is not limited to a shielding layer, and the configuration thereof is not limited. For example, it may be a layer containing a component having a high heat absorption property, for example, a metallic component, or a so-called low-emissivity film (low-E film), or a conductive layer formed by applying and firing a conductive paste containing metal particles such as silver. More specifically, the heat absorbing layer 50 may be a layer made of a metal (simple substance or alloy) or a layer containing metal particles, and the metal used in such a case may be silver, tin, zinc, titanium oxide, or the like. The thickness of the heat absorbing layer 50 is not particularly limited as long as the layer has heat absorption properties and can conduct the obtained heat to the adhesive.

The adhesive used in the present embodiment is not particularly limited as long as it is an adhesive used for bonding the window glass and the component, and may be an epoxy-based adhesive, a urethane-based adhesive, a silicone-based adhesive, a modified silicone-based adhesive, a melamine-based adhesive, a phenol-based adhesive, an acrylic-based adhesive, or the like. It may be a one-component type or a two-component type. The adhesive is preferably an adhesive whose curing is accelerated by heating, that is, a heat-triggered adhesive (an adhesive whose curing is accelerated by heating such as a thermal cation or a thermal radical), or an adhesive containing a thermosetting polymer as a main component. The adhesive may be a heat-curable adhesive (an adhesive that requires heating in a normal use mode) or a room-temperature-curable adhesive (an adhesive that is cured by being left in a normal use mode and does not require heating). In the method according to the present embodiment, however, the room-temperature-curable adhesive can be suitably used. Specific examples of the adhesive include a modified silicone/epoxy adhesive, a two-component urethane adhesive, a one-component thermosetting urethane adhesive, and a second generation acrylic adhesive (SGA).

The present embodiment is a method of producing the component-attached vehicle window glass 1 as illustrated in FIG. 1 and FIG. 2, in which the heat absorbing layer 50 in the vicinity of the component 30 is locally heated when the component 30 is bonded to the main surface of the vehicle window glass 10 with the adhesive 20. In the present specification, locally heating a predetermined part means not heating the entire structure combined with a predetermined component but locally increasing the temperature of a predetermined part. For example, in a case where the temperatures of the predetermined part and the other parts or other components are measured when the predetermined part is heated, the temperature of the predetermined part rises first or the temperature rising speed of the predetermined part is faster. Accordingly, the heat absorbing layer 50 can be locally heated by causing a heating device to face the heat absorbing layer 50 in the vicinity of the adhesive 20 or the component 30, or bringing the heating device into contact with the absorbing layer 50.

In the present embodiment, the adhesive is indirectly heated by locally heating the heat absorbing layer 50 and the adhesive is then cured, thereby exhibiting the adhesive function of the adhesive. In the method according to the present embodiment, the component is disposed on a part of the main surface of the window glass via the adhesive, and the heat absorbing layer 50 in the vicinity of the adhesive is then locally heated. In this method, since heating is not performed by heating the entire structure by heating the atmosphere in which the structure in which the component is disposed on the main surface of the window glass via the adhesive is placed, or the like, a housing or the like for covering the component is not required, for example. Furthermore, in order to increase the temperature of the atmosphere having a relatively large volume in the housing, a large-scale heating device may be required. In the present embodiment, such a large-scale device is, however, not required, and the device for producing the vehicle window glass described above can be made compact and the production cost can be suppressed.

Furthermore, according to the present embodiment in which the adhesive is heated by locally heating the heat absorbing layer in the vehicle window glass, the temperature of the adhesive can be raised in a short time. Therefore, the time required for raising the temperature of the adhesive to a target temperature (target temperature) can be shortened, and thus the producing efficiency of the component-attached vehicle window glass can be improved. Also, since the temperature rise of the portions other than the adhesive is suppressed, the portions other than the adhesive can be prevented from being damaged by heating.

The heating according to the present embodiment is preferably performed in a windless state. As used herein, the term “windless” means that no device which generates a flow of air or other gases (including steam) impinging on the structure including the window glass 10 and the component 30 disposed via the adhesive 20 is provided. By performing windless heating, positional deviation can be prevented in the attachment of a small component, and there is no or little change in the shape of the adhesive, and versatility is high.

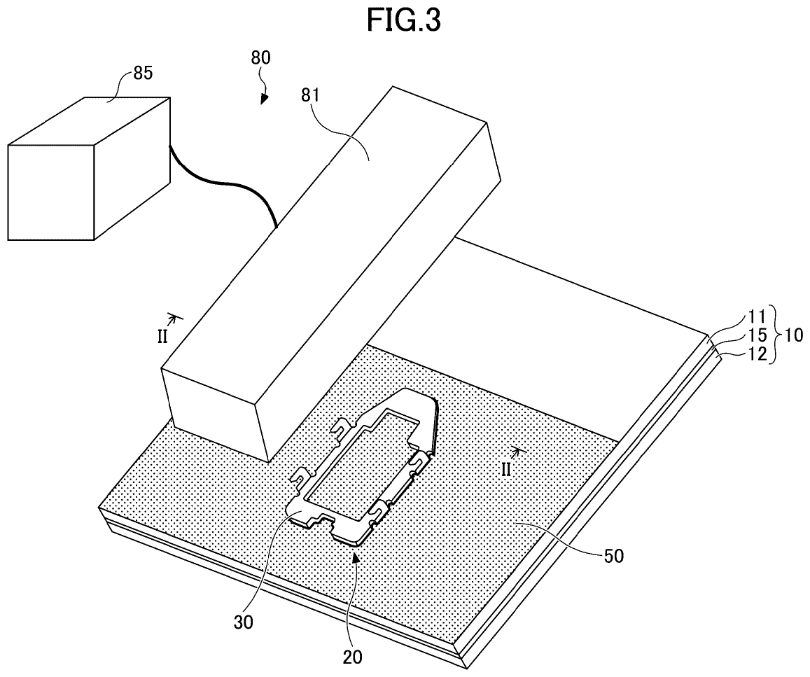

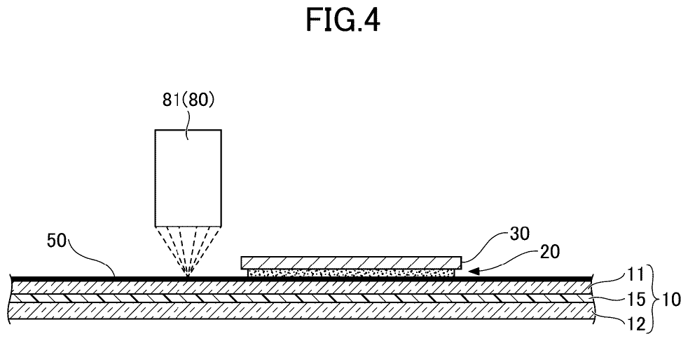

FIG. 3 schematically illustrates an example of a heating device used for heating in the producing method according to the present embodiment. FIG. 4 is a cross-sectional view taken along line II-II in FIG. 3.

In the producing method according to the present embodiment, first, the component 30 is disposed on the main surface of the vehicle window glass 10 via the adhesive 20. According to the example of FIG. 3 and FIG. 4, the adhesive 20 is disposed on the heat absorbing layer (shielding layer) 50 formed on the vehicle-interior surface side of the vehicle window glass 10, and the component 30 is disposed on the adhesive 20. That is, the adhesive is applied in contact with the heat absorbing layer 50 within a range where the heat absorbing layer 50 is formed in a plan view. Note that the entire adhesive 20 may not be in contact with the heat absorbing layer 50, only a part of the adhesive 20 may be in contact with the heat absorbing layer 50, or the adhesive 20 and the heat absorbing layer 50 may not be in contact with each other at all. In this embodiment, however, since the adhesive 20 is cured by conducting the heat obtained by the heat absorbing layer 50 to the adhesive 20, the adhesive and the heat absorbing layer 50 may be at least close to each other, and preferably in contact with each other. It is preferable that the entire adhesive is in contact with the heat absorbing layer 50.

In a case where the component 30 is disposed on the vehicle window glass 10 via the adhesive 20, the adhesive may be applied to the entire bonding surface (the surface facing the window glass 10) of the component 30 or may be partially applied. The thickness of the adhesive 20 is preferably between 0.1 mm and 4 mm, inclusive, before heating. Furthermore, a primer may be applied to the bonding surface of the component 30 as necessary before the component 30 and the adhesive 20 are brought into contact with each other, and a primer may be applied to the bonding surface of the window glass 10 as necessary before the window glass 10 and the adhesive are brought into contact with each other.

For the local heating of the heat absorbing layer 50, heat transfer by radiation, by conduction, or by radiation and conduction is preferably used. Above all, heat transfer by irradiating an electromagnetic wave having a predetermined wavelength is preferable. It is because heating can be performed in a non-contact manner with respect to the heat absorbing layer 50, and it can be applied to a component having a complicated surface shape. In a case where the heating device is a halogen lamp heater (halogen point heater, halogen line heater, for example) for heating by irradiating a near infrared ray (wavelength between 780 nm and 2500 nm, inclusive), since the electromagnetic energy is absorbed well by the heat absorbing layer, the heat absorbing layer can be heated in a concentrated manner, and the portions other than the heat absorbing layer can be prevented from being damaged by heating. Note that induction heat, laser heat, hot air, or the like can also be used for heating according to the present embodiment.

Although the heating method in the present embodiment does not exclude the use of hot water or steam, heating can be efficiently performed without using hot water or steam. Therefore, a drying step or the like is not required, and the curing of the adhesive can be more easily advanced compared to a conventional method in which a portion including the adhesive is immersed in water or disposed in superheated steam.

In the example illustrated in FIG. 3 and FIG. 4, a halogen line heating device is illustrated as a heating device 80. The halogen line heating device may include a halogen line heater main body 81 and a power supply and control part 85. The halogen line heater is a heater capable of linearly concentrating emitted infrared rays. It is preferable to use a halogen line heater having a focal length between 1 mm and 10 mm, inclusive. Furthermore, the heater is preferably installed so that the focal point is located on the surface of the heat absorbing layer 50 or in the heat absorbing layer 50.

Once the heat absorbing layer 50 is heated and increased in temperature, the heat from the heat absorbing layer 50 is conducted to the adhesive 20 located in the vicinity of the heat absorbing layer 50 or in contact with the heat absorbing layer 50. Thereby, the temperature of the adhesive 20 can be preferentially increased, and the curing speed can also be increased. In such a case, even if the component 30 is made of a material which is not heat-resistant, for example, a resin, the influence of heat on the component 30 which is not in contact with the heat absorbing layer 50 can be suppressed.

Furthermore, in a case where the vehicle window glass 10 is a laminated glass, the heating in the present embodiment can be performed without causing denaturation (foaming, discoloration, deformation, or the like) of the intermediate film included in the laminated glass. For example, heating according to the present embodiment can be performed at a temperature of the intermediate film of less than or equal to 100° C., preferably less than or equal to 80° C., and more preferably less than or equal to 50° C. In the conventional method of heating the bonding portion with superheated steam, portions other than the adhesive are also required to be heated in order to raise the temperature of the adhesive, and in the case where the vehicle window glass is a laminated glass, the resin constituting the intermediate film may be denatured, or the air sealed inside may expand to cause damage to the intermediate film, thereby causing problems such as foaming in the laminated glass, peeling, and discoloration of the intermediate film. On the other hand, in the method of locally heating the heat absorbing layer as in the present embodiment, an excessive temperature rise of the intermediate film can be suppressed while the temperature of the adhesive is rapidly rising. Therefore, the component can be bonded in a short time without damaging the laminated glass.

The local heating of the heat absorbing layer 50 in the present embodiment can be performed such that the temperature of the adhesive reaches a target temperature for curing the adhesive (target curing temperature). Here, the target curing temperature can be determined depending on the type of the adhesive, the type of the component, the configuration of the vehicle window glass, the desired curing degree of the adhesive, and the like. The target curing temperature may be determined, for example, by measuring the gelation time of the adhesive at multiple temperatures. The target curing temperature of the adhesive is a temperature higher than room temperature (15 to 25° C.), and may be, for example, between 40° C. and 100° C., inclusive.

Furthermore, in the heating in the present embodiment, the temperature reached by the heat absorbing layer 50 may be less than or equal to 100° C., and preferably less than or equal to 80° C.

In the present embodiment, the adhesive strength between the component and the vehicle window glass is also sufficient. For example, the adhesive strength of equal to or greater than 0.5 MPa can be realized by a measurement method according to a tensile adhesive strength test (JIS K 6849). Furthermore, a good cohesive failure ratio (CF ratio) of equal to or greater than 90% can be realized by an evaluation method according to the tensile adhesive strength test (JIS K 6849).

### EXAMPLES

Hereinafter, the embodiment of the present disclosure will be described in more detail based on examples. In the examples, under various conditions, a component was bonded to a main surface of window glass with an adhesive to produce component-attached automobile window glass.

In the present examples, measurement and evaluation were performed as follows.

### <Determination of Target Curing Temperature (Target Value) of Adhesive>

The target curing temperature is a desired temperature to be reached by the adhesive which is heated in the curing step. In a case where the temperature of the adhesive is raised to a high temperature in a short time, there is a concern that decomposition of the adhesive may occur. Whereas, in a case where the adhesive is heated at a low temperature, there is a possibility that a sufficient degree of curing cannot be obtained and the performance of the adhesive cannot be exhibited. It is also required that the target temperature is determined in consideration of the heat resistance of the adherend. In the examples, the gelation time was measured at multiple temperatures for each adhesive to be used, and the gelation temperature which is the highest temperature in a temperature range in which the adhesive or the adherend is not damaged was set as the curing target value. The gelation time was measured by a method according to the gelation time A method in JIS K 6910:2007.

### <Appearance Evaluation>

Each state of the component, the adhesive, and the laminated glass were evaluated by visual observation. If there was a change in either color, shape, or both compared to the state before the start of heating, the change was recorded as “discolored (including burnt)”, “deformed”, or the like. If there was no change in either color, shape, or both compared to the state before the start of heating, it was evaluated as “good”.

### <Curing Time>

The time from the start of heating (from the start of operation of the heating device) until the adhesive reached the above-described target curing temperature was recorded.

### <Adhesion Evaluation>

### (Strength)

One hour after the end of heating, the strength was measured by a method in accordance with the tensile adhesive strength test (JIS K 6849). Note that, in the case of an example in which heating was not performed (Example 9), the strength was measured one hour after the component was disposed on the window glass via the adhesive.

(CF Ratio after Hot Water Test)

After complete curing, the component was immersed in hot water at 40° C. for 240 hours. Thereafter, evaluation was performed by the tensile adhesive strength test (JIS K 6849). The state of failure was visually observed, and the ratio of the area where the adhesive underwent cohesive failure with respect to the area to which the adhesive had been applied was taken as the cohesive failure ratio (CF ratio in %). Note that a CF ratio of 0% is a state in which the adhesive does not undergo cohesive failure at all but interfacial peeling occurs, and a CF ratio of 100% is a state in which the adhesive undergoes cohesive failure over the entire surface to which the adhesive had been applied. The higher the CF ratio, the greater the rate of occurrence of cohesive failure in the adhesive, and thus the adhesion between the component and the adhesive was better.

### Example 1

A sample (100 mm×100 mm) of laminated glass was prepared by bonding two glass plates having a thickness of 2 mm to each other via a polyvinyl butyral intermediate film (0.73 mm). A shielding layer formed by firing a ceramic paste was formed on one surface of the laminated glass sample. A total of 0.6 g of a two-component silicone/epoxy adhesive (“MOS400” produced by Konishi Co., Ltd.) was applied to the entire bonding surface of a bracket made of polybutyleneterephthalate (PBT) (length: 80 mm, maximum width: 50 mm, area of bonding surface: approximately 500 mm²), and the surface coated with the adhesive was placed on the surface of the laminated glass sample on which the shielding layer was formed. At this time, the adhesive sandwiched between the bracket (component) and the laminated glass was made to be 1.0 mm thick. Note that the area of the bonding surface of the bracket (component) is an area of a flat surface on a side facing the main surface of the window glass.

As a heating device, a device provided with a halogen line heater (near-infrared heater, “LHW-30” produced by Fintech Co., Ltd.) having a mirror length of 84 mm was used. The heater was arranged on the side where the bracket is provided and being spaced apart from the shielding layer such that the irradiation port of the heater was opposite the shielding layer. At this time, the heater was arranged such that the distance from the opening of the heater to the opposing surface of the shielding layer was 20 mm. The focal distance was 20 mm and the focal width was 2.5 mm. The halogen line heater was arranged such that the distance from the position of the focal point thereof to the adhesive was 5 mm. The halogen line heater was operated under the conditions of the power of 25V and the irradiation time of 90 seconds. Heating by the heating device was performed until the temperature of the adhesive reached a target curing temperature while measuring the temperature of the adhesive, the temperature of the shielding layer formed on the laminated glass, and the temperature of the intermediate film. After heating, for the component-attached laminated glass (component-attached automobile window glass) obtained in each example, the adhesive strength of the adhered portion and the CF ratio after the hot water test were determined.

### Example 2

In the same manner as in Example 1 except that the bracket was replaced with the bracket made of polyamide (PA) (the size and shape of the bracket were also the same as in Example 1), the bracket was disposed on the shielding layer of the laminated glass via the adhesive, and heating was performed with the halogen line heater.

### Example 3

In the same manner as in Example 1 except that the bracket was replaced with the bracket made of polycarbonate (PC) (the size and shape of the bracket were also the same as in Example 1), the bracket was disposed on the shielding layer of the laminated glass via the adhesive, and heating was performed with the halogen line heater.

### Example 4

An experiment was performed in the same manner as in Example 1 except that the adhesive was replaced with a one-component thermosetting urethane adhesive (“Penguin Cement #8800” produced by Sunstar Inc.) and a primer (“SC-241” produced by Sunstar Inc.) was applied to the bonding surface of the glass before the adhesive was applied.

### Example 5

An experiment was performed in the same manner as in Example 1 except that the adhesive was replaced with a two-component urethane adhesive (“Hysol-10FL” produced by Henkel Japan Ltd.).

### Example 6

In the same manner as in Example 1 except that the bracket was replaced with a bracket made of iron (the size and shape of the bracket were also the same as in Example 1), the bracket was disposed on the shielding layer of the laminated glass via the adhesive, and heating was performed with the halogen line heater.

### Example 7

The bracket was replaced with a stainless steel mirror base (length: 700 mm, maximum width: 250 mm, area of bonding surface: approximately 950 mm²), a total of 1.1 g of a two-component silicone/epoxy adhesive used in Example 1 was applied to the entire bonding surface of the mirror base, and the surface coated with the adhesive was placed on the surface of the laminated glass sample on which the shielding layer was formed. The adhesive sandwiched between the mirror base and the laminated glass was made to be 1.0 mm thick. Under the same conditions as in Example 1, heating was performed with the halogen line heater.

### Example 8

The same procedure as in Example 1 was followed except that no heating was performed. That is, the bracket was disposed via the adhesive on the surface of the laminated glass sample on which the shielding layer was formed.

### Example 9

An experiment was performed in the same manner as in Example 1 except that an oven was used as the heating device instead of the halogen line heater. The bracket was disposed via the adhesive on the surface of the laminated glass sample on which the shielding layer was formed, and was then placed in the oven (“PV-222” produced by ESPEC CORP.). The oven was operated at 60° C.

### Example 10

An experiment was performed in the same manner as in Example 1 except that a far-infrared heater was used as the heating device instead of the halogen line heater. More specifically, the heating surface of the far-infrared heater (“QFE-125” produced by Nippon Heater Co., Ltd.) was opposite the exposed surface of the mirror base with a 200 mm gap therebetween, and the heater was operated under the conditions of the power of 125 W and the heating time of 150 seconds.

Table 1 illustrates the experimental conditions and results. Examples 1 to 7 are examples, and Examples 8 to 10 are comparative examples.

TABLE 1

| | | | Example 1 | Example 2 | Example 3 | Example 4 | Example 5 |
|---|---|---|---|---|---|---|---|
| Condition | Heating device | | Halogen lamp | Halogen lamp | Halogen lamp | Halogen lamp | Halogen lamp |
| | Adherend | Type | Bracket | Bracket | Bracket | Bracket | Bracket |
| | | Material | PBT | PA | PC | PBT | PBT |
| | Adhesive | | Two-component | Two-component | Two-component | One-component | Two-component |
| | | | silicone/epoxy | silicone/epoxy | silicone/epoxy | thermosetting | urethane |
| | | | | | | urethane | |
| | Target curing temperature | | 60° C. | 60° C. | 80° C. | 80° C. | 80° C. |
| | (adhesive temperature) | | | | | | |
| Evaluation | Temperature | Glass | ≤80° C. | ≤80° C. | ≤60° C. | >80° C. | ≤60° C. |
| | | (shielding layer) | | | | | |
| | | Intermediate film | <80° C. | <80° C. | <60° C. | <80° C. | <60° C. |
| | Appearance | Component | Good | Good | Good | Good | Good |
| | | Adhesive | Good | Good | Good | Good | Good |
| | | Laminated glass | Good | Good | Good | Good | Good |
| | Curing time | | ≤90 seconds | ≤90 seconds | ≤90 seconds | ≤120 seconds | ≤80 seconds |
| | (time to reach target | | | | | | |
| | curing temperature) | | | | | | |
| | Adhesion | Strength after 1 | 1.0 MPa | 0.9 MPa | 1.0 MPa | 0.7 MPa | 0.8 MPa |
| | | hour | | | | | |
| | | CF ratio after hot | CF 100% | CF 100% | CF 100% | CF 100% | CF 100% |
| | | water test | | | | | |
| | | | Example 6 | Example 7 | Example 8 | Example 9 | Example 10 |
| Condition | Heating device | | Halogen lamp | Halogen lamp | None | Oven | Infrared heater |
| | | | | | | | (flat surface |
| | | | | | | | heat) |
| | Adherend | Type | Bracket | Mirror base | Bracket | Bracket | Bracket |
| | | Material | Iron | Stainless steel | PBT | PBT | PBT |
| | Adhesive | | Two-component | Two-component | Two-component | Two-component | Two-component |
| | | | silicone/epoxy | silicone/epoxy | silicone/epoxy | silicone/epoxy | silicone/epoxy |
| | Target curing temperature | | 60° C. | 60° C. | 60° C. | 60° C. | 60° C. |
| | (adhesive temperature) | | | | | | |
| Evaluation | Temperature | Glass | ≤60° C. | ≤60° C. | Room | 60° C. | 92° C. |
| | | (shielding layer) | | | Temperature | | |
| | | Intermediate film | <80° C. | <80° C. | Room | 80° C. | 90° C. |
| | | | | | Temperature | | |
| | Appearance | Component | Good | Good | Good | Good | Deformed resin |
| | | Adhesive | Good | Good | Good | Goor | Good |
| | | Laminated glass | Good | Good | Good | Good | Good |
| | Curing time | | ≤120 seconds | ≤120 seconds | n/a | 20 minutes | 150 seconds |
| | (time to reach target | | | | | | |
| | curing temperature) | | | | | | |
| | Adhesion | Strength after 1 | 0.6 MPa | 0.6 MPa | 0.2 MPa | 1.0 MPa ^{*1} | n/a |
| | | hour | | | | | |
| | | CF ratio after hot | CF 100% | CF 100% | CF 100% | CF 100% | n/a |
| | | water test | | | | | |

^{*1} Strength measured 1 hour after the component is disposed on the window glass via the adhesive.

As illustrated in Table 1, in Examples 1 to 7 in which the adhesive was indirectly heated by locally heating the shielding layer (heat absorbing layer) in the vicinity of the component, the temperature of the adhesive reached the desired temperature (target curing temperature) in a short time, and there was no damage to portions other than the adhesive, that is, the component itself and the laminated glass (particularly, the intermediate film). Furthermore, the adhesion of the component of the component-attached automobile window glass obtained in Examples 1 to 7 was also sufficient.

On the other hand, in Example 8 in which heating was not performed, the adhesion was evaluated after the same time as in Example 1, but the adhesion of the component was low. Furthermore, in the case of Examples 9 and 10 in which heating was performed but the shielding layer was not locally heated, it took time for the temperature of the adhesive to reach the desired temperature. In particular, in Example 10, it was found that the resin component was disadvantageously deformed.

Although the present disclosure has been described based on the embodiment and examples, the present disclosure is not limited to the embodiment and examples. Various changes, modifications, substitutions, additions, deletions, combinations, and the like can be made to the above-described embodiment within the scope described in the claims, and these also belong to the technical scope of the present disclosure.

According to an aspect of the present disclosure, component-attached vehicle window glass can be produced in a short time and in a space-saving manner.

What is claimed is:

1. A method of producing component-attached vehicle window glass, the method comprising:
disposing a component on a main surface of a glass plate having a heat absorbing layer via an adhesive;
locally heating the heat absorbing layer; and
transferring heat from the heat absorbing layer to the adhesive to heat and cure the adhesive.

2. The method of producing component-attached vehicle window glass according to claim 1, wherein the component is made of resin.

3. The method of producing component-attached vehicle window glass according to claim 1, wherein the heating of the heat absorbing layer is performed by radiation, by conduction, or by radiation and conduction.

4. The method of producing component-attached vehicle window glass according to claim 1, wherein the heating of the heat absorbing layer is performed in a windless state.

5. The method of producing component-attached vehicle window glass according to claim 4, wherein the heating of the heat absorbing layer is performed with a near-infrared heater.

6. The method of producing component-attached vehicle window glass according to claim 1, wherein the component is a component for mounting an in-vehicle item.

7. The method of producing component-attached vehicle window glass according to claim 1, wherein the adhesive is an adhesive whose curing is accelerated by heating.

8. The method of producing component-attached vehicle window glass according to claim 1, wherein the vehicle window glass is laminated glass in which two glass plates are bonded to each other via an intermediate film.

9. The method of producing component-attached vehicle window glass according to claim 8, wherein a temperature of the intermediate film does not exceed 100° C.

10. The method of producing component-attached vehicle window glass according to claim 1, wherein the heat absorbing layer is a layer formed by firing a ceramic paste provided on a peripheral edge portion of the vehicle window glass.
